(19) United States
(12) Patent Application Publication
(10) Pub. No.: US 2017/0206458 A1
(43) Pub. Date: Jul. 20, 2017

(54) COMPUTER-READABLE RECORDING MEDIUM, DETECTION METHOD, AND DETECTION APPARATUS

(71) Applicant: FUJITSU LIMITED, Kawasaki-shi (JP)

(72) Inventors: Yoshinori Sakamoto, Kawasaki (JP); Masazumi Matsubara, Machida (JP); Kenji KOBAYASHI, Kawasaki (JP); Yusuke KOYANAGI, Kawasaki (JP)

(73) Assignee: FUJITSU LIMITED, Kawasaki-shi (JP)

(21) Appl. No.: 15/378,184

(22) Filed: Dec. 14, 2016

(30) Foreign Application Priority Data
Jan. 15, 2016 (JP) 2016-006453

(51) Int. Cl. G06N 7/00

(52) U.S. Cl. CPC G06N 7/005

(57) ABSTRACT

A non-transitory computer-readable recording medium stores a program that causes a computer to execute a process including: performing a first conversion processing to convert a value indicating each event, and to convert, based on conversion information that indicates a group of the value and an identification value that corresponds to values belonging to the group; constructing information with occurrence probabilities by connecting identification values; performing second conversion processing to convert a value indicating each event included in event data, and to convert values that belong to a group indicated in the conversion information into an identical identification value corresponding to the group based on the conversion information; and detecting an anomaly based on a result of comparison between the constructed information and the identification value.

### CROSS-REFERENCE TO RELATED APPLICATION

This application is based upon and claims the benefit of priority of the prior Japanese Patent Application No. 2016-006453, filed on Jan. 15, 2016, the entire contents of which are incorporated herein by reference.

### FIELD

The embodiment discussed herein is related to a computer-readable recording medium, a detection method, and a detection apparatus.

### BACKGROUND

Conventionally, anomaly detection for a system, operation, and the like by analyzing big data (hereinafter, referred to as history log), such as a log of a system and measurement data has been proposed. In this anomaly detection, a risk tree in which an anomaly event included in a history log is arranged at the top, and other anomaly events that occur due to the anomaly event are arranged as following events, and that indicates a risk value of each anomaly event is stored. When successive events occur in real time in a system in a sequence indicated in the risk tree, an anomaly in the system in a current state is detected (Japanese Laid-open Patent Publication Nos. 7-217963, 9-231321, 2014-126882).

As a method learning an occurrence sequence (pattern) of an event and an occurrence probability of each event to reflect to a tree to which the occurrence probability of each event has been added, there has been a probabilistic suffix tree (PST). In this PST, a PST obtained as a result of learning and an occurrence sequence (pattern) of current events are compared. When the current pattern is new (no such path exists in the PST) or is a rare pattern (pattern with a significantly low occurrence probability), an anomaly that is “unusual” can be detected.

For the anomaly detection, real time detection enabling to detect an anomaly in real time is demanded. Therefore, when considering to adopt PST in the anomaly detection, a PST is to be stored in a memory such as a random access memory (RAM). However, a region length (memory usage) of a PST increases sharply in proportion to a product of the number of levels of patterns and the number of elements in each level in the PST. When the memory usage increases as such, storage of a PST in a memory is difficult.

### SUMMARY

According to an aspect of an embodiment, a non-transitory computer-readable recording medium stores therein a detection program that causes a computer to execute a process including: performing a first conversion processing to convert a value indicating each event that is included in history log into an identification value corresponding to the value, and to convert, based on conversion information that indicates a group of the value and an identification value that corresponds to values belonging to the group, values that belong to a group indicated in the conversion information into an identical identification value that corresponds to the group; constructing information with occurrence probabilities by connecting identification values that are obtained by conversion by the first conversion processing in order of occurrence of the event sequentially from a root, and by assigning an occurrence probability of an event that corresponds to the identification value per identification value; performing second conversion processing to convert a value indicating each event included in event data that is input according to an event has occurred into an identification value corresponding to the value, and to convert values that belong to a group indicated in the conversion information into an identical identification value corresponding to the group based on the conversion information; and detecting an anomaly based on a result of comparison between the constructed information with occurrence probabilities and the identification value that is obtained by conversion by the second conversion processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting a configuration example of a detection apparatus according to an embodiment;

FIG. 2 is an explanatory diagram explaining an overview of anomaly detection;

FIG. 3 is a flowchart indicating one example of processing for construction of a PST;

FIG. 4 is an explanatory diagram explaining definition/rule information;

FIG. 5 is an explanatory diagram explaining learning by statistical processing;

FIG. 6 is an explanatory diagram explaining construction of a PST based on a conversion table;

FIG. 7 is an explanatory diagram explaining a case in which elements following a root are replaced in a PST;

FIG. 8 is a flowchart indicating one example of processing in the anomaly detection;

FIG. 9 is a flowchart indicating one example of processing for construction of a PST;

FIG. 10 is an explanatory diagram explaining the definition/rule information;

FIG. 11 is an explanatory diagram explaining replacement of substrings in a PST;

FIG. 12 is a flowchart indicating one example of processing for reconstruction of a PST;

FIG. 13 is an explanatory diagram explaining reconstruction of a PST;

FIG. 14 is a flowchart indicating one example of processing for reconstruction of a PST;

FIG. 15 is a flowchart indicating one example of processing for division/cut of a PST;

FIG. 16 is an explanatory diagram explaining division/cut of a PST; and

FIG. 17 is a block diagram depicting one example of a hardware configuration of a detection apparatus according to the embodiment.

### DESCRIPTION OF EMBODIMENT

Preferred embodiments of the present invention will be explained with reference to accompanying drawings. The same reference symbol is given to components having the same function in an embodiment, and duplicated explanation is omitted. The detection program, the detection method, and the detection apparatus explained in the following embodiment are only one example, and are not intended to limit embodiments. Moreover, the following embodiments can be combined as appropriate within a range not causing a contradiction.

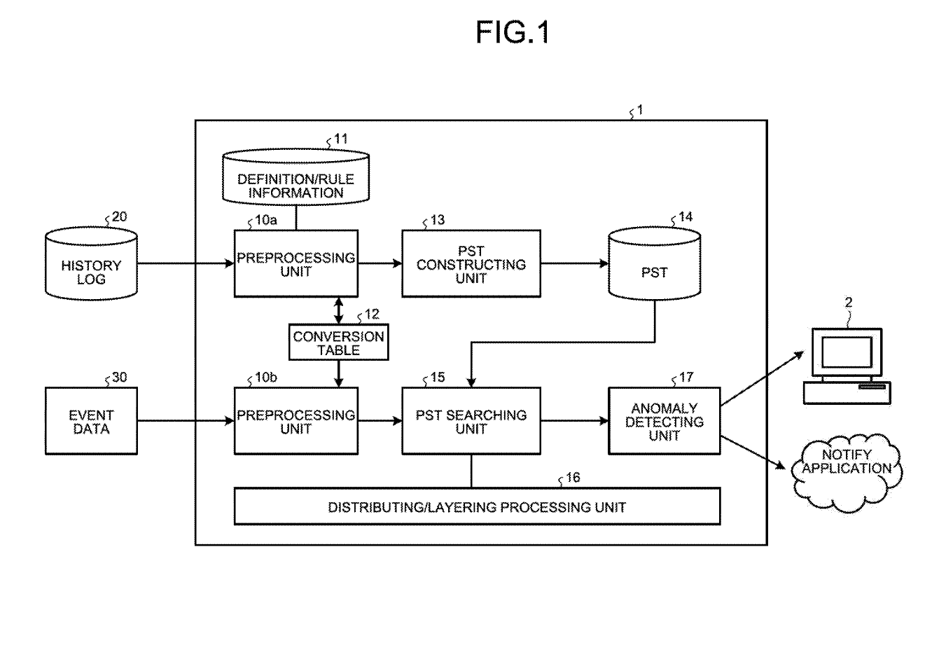

FIG. 1 is a block diagram depicting a configuration example of a detection apparatus 1 according to an embodiment. The detection apparatus 1 depicted in FIG. 1 is an information processing apparatus such as a personal computer (PC).

The detection apparatus 1 constructs a PST 14 by reading a history log 20 that are big data such as a log and measurement data of a large-scale computer system, a network system, and the like, and in which events that have occurred once are described in chronological order. The detection apparatus 1 accepts event data 30 that is input according to an event occurring in real time in a system of a subject of monitoring, detects an anomaly in the system of a subject of monitoring based on a comparison result between the constructed PST 14 and the event data 30, and informs the detection result to a user. For example, the detection apparatus 1 outputs a detection result of the anomaly detection to another terminal device 2 or a predetermined application, and informs the detection result to the user by displaying the detection result in the terminal device 2 or by notification by the application.

Events in the history log 20 and the event data 30 can be of various kinds, and not particularly limited. For example, when a cyberattack to a system of a subject of monitoring is detected as anomaly, an events can be mail reception, mail operation, PC operation, a web access, data communication, or the like. Moreover, when unauthorized entrance to a system of a subject of monitoring is detected as anomaly, an event can be an action of a user that is detected by an image taken by a monitoring camera or an operation of a card key. Furthermore, when an environmental abnormality in a system of a subject of monitoring is detected as anomaly, an event can be temperature, humidity, or the like detected by a sensor. Moreover, in a system of monitoring a stock market and the like, a stock price of each brand, weather information, a comment in a social networking service (SNS), and the like can be an event.

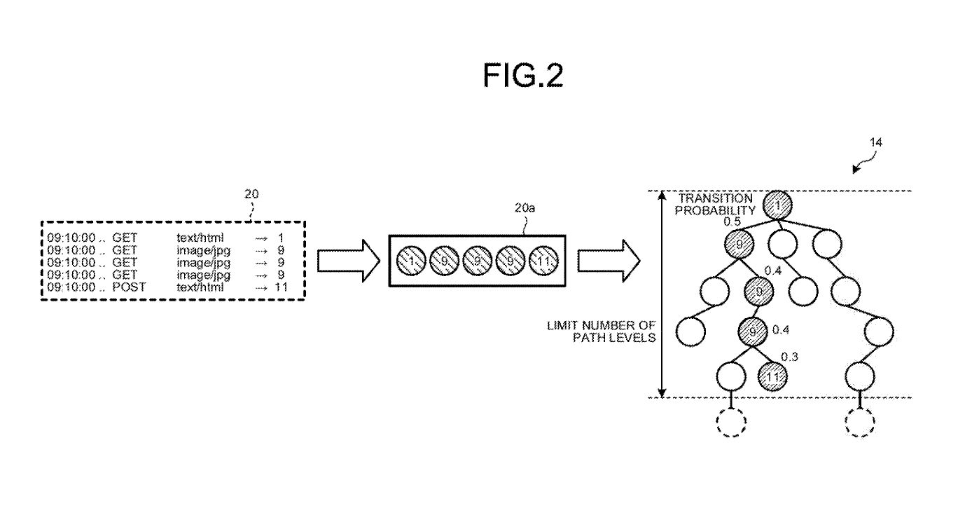

FIG. 2 is an explanatory diagram explaining an overview of the anomaly detection. The history log 20 depicted in FIG. 2 is one example of a series of event that starts with “GET text/html” in data communication of a proxy server and the like.

As depicted in FIG. 2, the detection apparatus 1 converts events described in chronological order in the history log 20 into identification values. In the depicted example, “GET text/html” is converted into an identification value “1”, and “GET image/jpg” is converted into “9”, and “POST text/html” is converted into “11”. Subsequently, the detection apparatus 1 generates a pattern 20a in which identification values are arranged in order of occurrence of the events.

Subsequently, the detection apparatus 1 connects the identification values (1, 9, 9, 9, 11) in the order of occurrence of the events from a root to branches. For example, for the identification values having a trunk (path) from the root (duplicated identification values) are connected so as to follow the same path. The identification values having no path (not duplicated) are arranged to be structured as a tree with a new branch. Subsequently, the detection apparatus 1 adds an occurrence probability (transition probability) of the event corresponding to the identification value to each of the identification values in the tree structure, to construct the PST 14. Specifically, a transition probability is calculated by using the total number of events as a denominator, and the number of occurrence of each event (the number of times of passing through a path of identification values) as a numerator, and the calculated transition probability is added to each identification value. The number of path levels in the PST 14 can be limited to suppress increase of the memory usage.

The detection apparatus 1 converts events that are described in chronological order in the event data 30 into identification values similarly to the history log 20, and arranges the identification values in order of occurrence, thereby generating a pattern (current pattern) that indicates the current state of the system. Subsequently, the detection apparatus 1 compares the constructed PST 14 with the current pattern that is obtained by conversion from the event data 30. When the current pattern is new (no such path exists in the PST 14) or is a rare pattern (pattern with a significantly low occurrence probability, lower than a predetermined value), an anomaly is detected.

As depicted in FIG. 1, the detection apparatus 1 includes a preprocessing units 10a and 10b, a detection/rule information 11, a conversion table 12, a PST constructing unit 13, the PST 14, a PST searching unit 15, a distributing/layering processing unit 16, and an anomaly detecting unit 17.

The preprocessing units 10a and 10b perform preprocessing, such as data shaping/processing, for input data. The preprocessing unit 10a subjects the history log 20 that is input by the system of a subject of monitoring to preprocessing, and outputs the processed data to the PST constructing unit 13. The preprocessing unit 10b subjects the event data 30 that is input by the system of a subject of monitoring to preprocessing, and outputs the processed data to the PST searching unit 15. Note that the preprocessing units 10a and 10b can be configured without being separated for the history log 20 and the event data 30, but it can be configured such that a single preprocessing unit is shared.

The preprocessing performed by the preprocessing units 10a and 10b includes conversion processing to convert a value (details) of each event included in the history log 20 and the event data 30 into a corresponding identification value based on a predetermined rule. This identification value can be a numeric value, a character, a symbol, or a combination of a numeric value, a character, and a symbol that corresponds to the details of an event, and is not particularly limited. In the present embodiment, a value of an event is converted into a numeric value by the preprocessing by the preprocessing units 10a and 10b, as one example.

Moreover, the preprocessing performed by the preprocessing units 10a and 10b includes conversion processing to convert values that belong to a group indicated in the conversion table 12 into an identical identification value corresponding to the group, based on the conversion table 12 that indicates a group of values of each event, and an identification value that corresponds to the values belonging to the group. By this conversion processing, when values of respective events included in the history log 20 and the event data 30 belong to the group indicated in the conversion table 12, the values are uniformly converted into the same identification value, thereby reducing the number of elements of the PST 14.

Furthermore, the processing performed by the preprocessing unit 10a includes processing of calculating a statistical distribution of values indicating respective events that are included in the history log 20 according to definition/rule indicated in the definition/rule information 11, and of making a group based on a range of values according to the calculated statistical distribution, and of creating the conversion table 12 in which an identification value corresponding to this group is defined. By thus creating the conversion table 12, grouping according to a statistical distribution of values that indicate respective events can be done in the preprocessing that is performed by the preprocessing units 10a and 10b.

Moreover, the processing performed by the preprocessing unit 10a includes processing of calculating an appearance frequency of a sequence in chronological order according to definition/rule indicated in the definition/rule 11, for values indicating respective events that are included in the history log 20, and of making a group based on a sequence, the calculated appearance frequency of which is equal to or higher than a predetermined value, and of creating the conversion table 12 in which an identification value corresponding to this group is defined. By thus creating the conversion table 12, a sequence, the appearance frequency of which is equal to or higher than a predetermined value, that is, a pattern of frequent appearance, is uniformly converted into an identical identification value, thereby reducing the number of path levels in the PST 14.

The definition/rule information 11 is information indicating definitions and rules, and for example, definitions and rules relating to calculation of the statistical distribution and the appearance frequency described above, and the like are indicated therein. The definition/rule information 11 is specified by a user in advance and stored in a storage device such as a memory and a hard disk drive HDD).

The PST constructing unit 13 constructs the PST 14 based on the history log 20 subjected to the preprocessing. The constructed PST 14 is stored in a storage device such as a memory and an HDD. The PST searching unit 15 compares the PST 14 constructed from the history log 20 with the event data 30 subjected to the preprocessing, and searches for a tree that matches the current pattern obtained by converting from the event data 30. The search result by the PST searching unit 15 is output to the anomaly detecting unit 17.

The distributing/layering processing unit 16 distributes/layers respective processing in the detection apparatus 1 by using plural threads, and the like. For example, the distributing/layering processing unit 16 distributes/layers processing for the PST search in the PST searching unit 15, and the anomaly detection in the anomaly detecting unit 17. By thus distributing/layering the processing in the PST searching unit 15 and the anomaly detecting unit 17, real time detection of the anomaly detection can be improved. Note that the distribution and layering of processing by the PST searching unit 15 can be applied to the respective processing in the preprocessing units 10a and 10b, and the PST constructing unit 13.

The anomaly detecting unit 17 performs anomaly detection based on a search result by the PST searching unit 15. Specifically, when there is no matching tree as a result of searching by the PST searching unit 15, the current pattern is new (there is no path in the PST), and therefore detected as an anomaly. Moreover, when there is a matching tree as a result of searching by the PST searching unit 15, if the transition probability added to the tree is equal to or lower than a predetermined value and is significantly low, it is detected as an anomaly. The anomaly detecting unit 17 outputs the detection result to the terminal device 2 or a predetermined application.

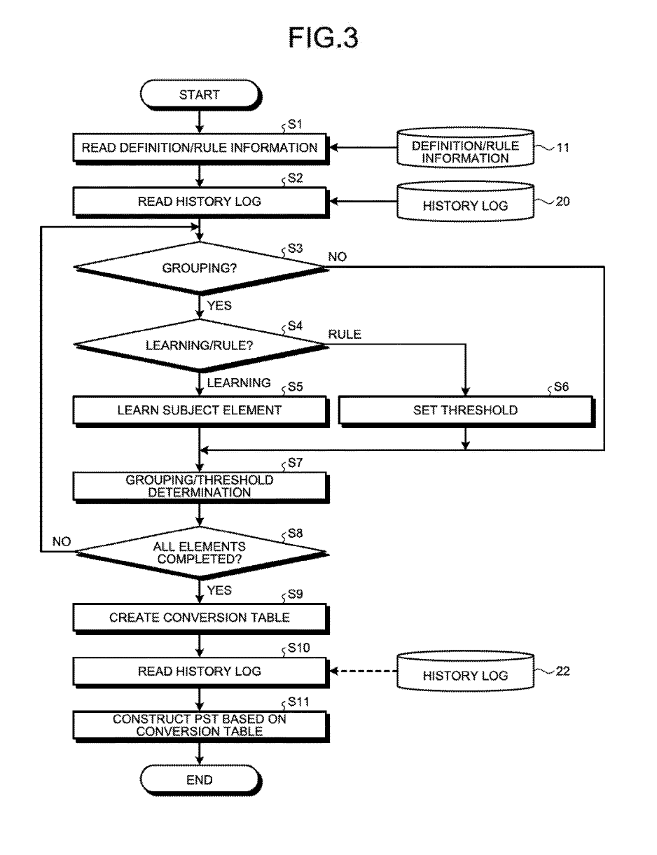

Details of the processing for construction of the PST 14 are explained. FIG. 3 is a flowchart indicating one example of processing for construction of the PST 14.

As indicated in FIG. 3, when processing is started, the preprocessing unit 10a reads the definition/rule information 11 that is stored in a memory or the like (S1).

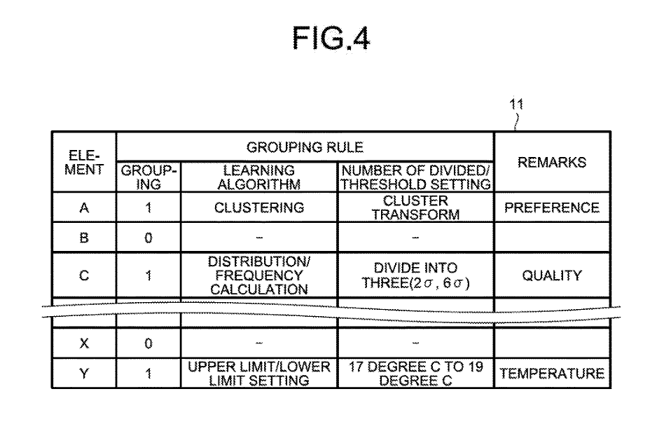

FIG. 4 is an explanatory diagram explaining the definition/rule information 11. As depicted in FIG. 4, in the definition/rule information 11, definitions and rules, such as a grouping rule and remarks per event (elements A to Y) that is included in the history log 20 are indicated. In the grouping rule, whether to perform grouping (1 or 0), a learning algorithm indicating a statistical processing and the like performed when grouping is performed, and the number of division/threshold to be set are indicated.

Following S1, the preprocessing unit 10a reads the history log 20 (S2). Subsequently, the preprocessing unit 10a performs processing at S3 to S7 per event (elements A to Y) that is included in the history log 20.

Specifically, at S3, the preprocessing unit 10a refers to the grouping rule per event (elements A to Y) indicated in the definition/rule information 11, and determines whether to perform grouping of the elements of a subject of processing (S3). When it is determined not to perform grouping (S3: NO), the preprocessing unit 10a skips processing at S4 to S6 and proceeds the processing to S7.

When it is determined to perform grouping (S3: YES), the preprocessing unit 10a refers to the grouping rule per event (elements A to Y) indicated in the definition/rule information 11, and determines which learning/rule is used for grouping (S4).

For example, when statistical processing such as “clustering” and “distribution/frequency calculation” is indicated in the grouping rule, it is determined that grouping is performed by learning. Moreover, when a rule such as “upper limit/lower limit setting” is indicated in the grouping rule, it is determined to perform grouping by rule.

When grouping is performed by learning at S4, the preprocessing unit 10a acquires a statistical distribution of events that are included in the history log 20 by the statistical processing indicated in the grouping rule, and performs learning for a subject element (S5).

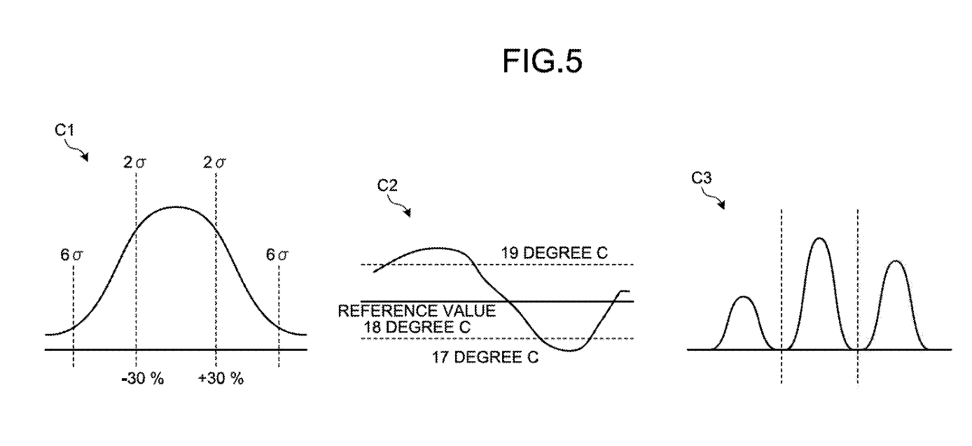

FIG. 5 is an explanatory diagram explaining learning by statistical processing. As depicted in FIG. 5, a case C1 is a case in which values within certain values (for example 6σ, 2σ in product quality, +30%, −30% in stock price, and the like) relative to a standard deviation (σ) matter. For elements of this case C1, statistical processing such as “distribution/frequency calculation” is indicated in the grouping rule, and a standard deviation (σ) and the like necessary for grouping is acquired by the statistical processing.

A case C2 is a case in which a certain range (successive values) matters such as temperature and humidity. For elements of this case C2, a rule such as “upper limit/lower limit setting” is indicated in the grouping rule, and a threshold corresponding to a certain range is set.

A case C3 is a case in which a distribution of a specific group (cluster) appears as a result of statistics/analysis, such as a preference. For elements of this case C3, statistical processing such as “clustering” is indicated in the grouping rule, and a cluster transform for grouping is acquired by the statistical processing.

When grouping is performed by the rule at S4, the preprocessing unit 10a perform threshold setting corresponding to a range, such as “17 degrees Celsius (C.) to 19 degrees C.”, indicated in the grouping rule (S6).

Subsequently, the preprocessing unit 10a determines a threshold for grouping of elements based on a result of the learning of subject elements (S5), or the threshold setting (S6). For example, when a standard deviation (σ) is acquired by statistical processing such as “distribution/frequency calculation” in the learning of the subject elements, thresholds (2σ, 6σ) to divide into three are determined using the standard deviation (σ). When grouping is not performed (S3: NO), it determines as no threshold.

Subsequently, the preprocessing unit 10a determines whether the processing at S3 to S7 have been completed for all of the elements of the event included in the history log 20 (S8). When the processing has not completed for the all of the elements (S8: NO), the preprocessing unit 10a returns the processing to S3 to perform the processing at S3 to S7 for a next element.

When the processing has been completed for all of the elements (S8: YES), the preprocessing unit 10a creates the conversion table 12 in which a unique identification value is assigned to a range of grouping determined by the processing of grouping/threshold determination (S7) for each element (S9). When the conversion table 12 has been set in advance by a user or the like, the processing from S1 to S9 described above can be omitted.

Subsequently, the preprocessing unit 10a reads the history log 20 (S10), and converts a value (details) of each event included in the history log 20 into a corresponding identification value based on the rule defined in advance. Moreover, as for values that belong to a group indicated in the conversion table 12, the preprocessing unit 10a converts the values into the same identification value corresponding to the group based on the conversion table 12. The PST constructing unit 13 then constructs the PST 14 based on the history log 20 subjected to conversion (S11).

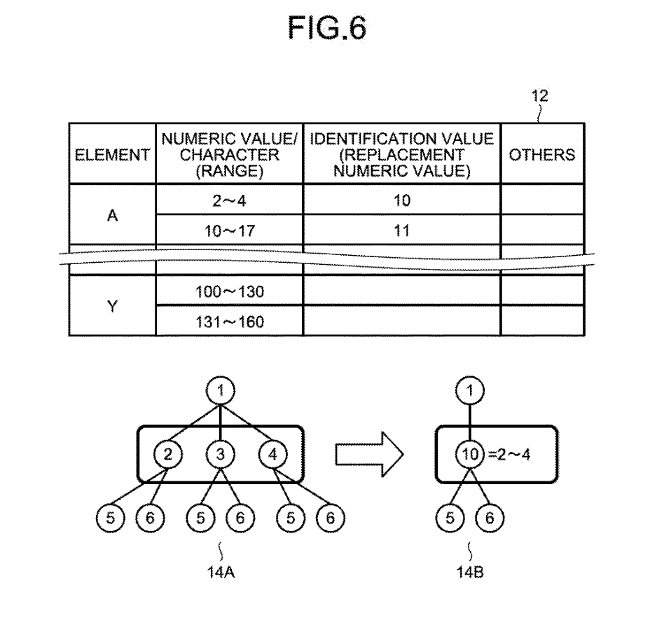

FIG. 6 is an explanatory diagram explaining construction of a PST based on the conversion table 12. As depicted in FIG. 6, the conversion table 12 has a group, which is a range of numeric value/character in each element, and an identification value to convert a value belonging to the group into. For example, in the conversion table 12, it is indicated that for element (A) that is first from the root, numeric values “2 to 4” are converted into an identification value “10”. Therefore, compared to a PST 14A that is constructed with independent identification values, the number of elements can be reduced in a PST 14B in which the numeric values “2 to 4” of element A are replaced with “10”, and the horizontal width in the tree structure can be narrowed.

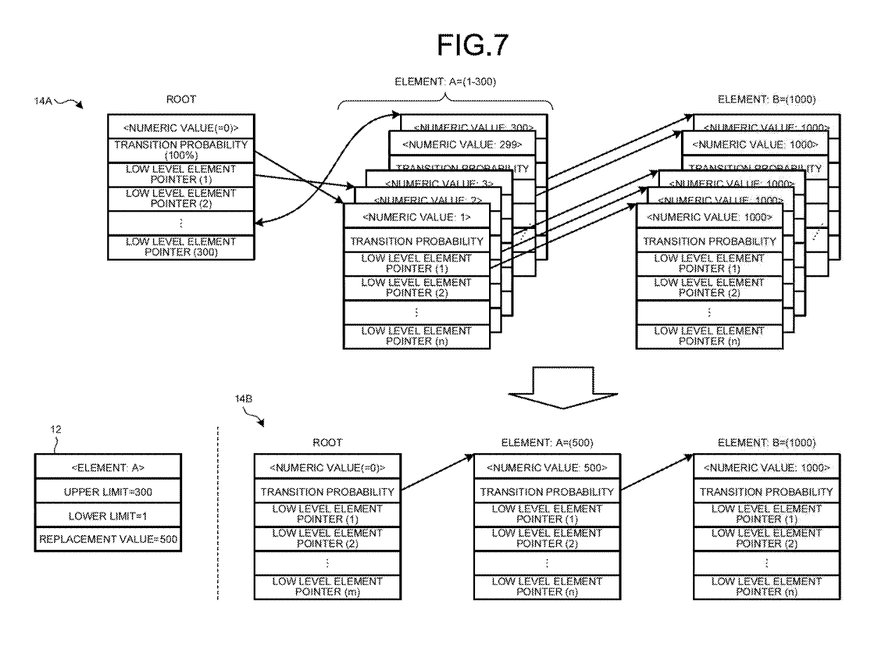

FIG. 7 is an explanatory diagram explaining a case in which elements following a root are replaced in a PST. In FIG. 7, the tree structures from the root to the respective elements in the PST 14A and PST 14B are expressed as data in a table format that is referred to sequentially from the root by a lower-level element pointer.

As depicted in FIG. 7, the PST 14A constructed with independent identification values has 300 elements that corresponds to numeric values 1 to 300 at the first level (element: A) from the root, and has 1 element corresponding to a single numeric value 1000 at the second level (element: B). To the contrary, the PST 14B in which the elements following the root are replaced based on the conversion table 12 indicating that for the first level (element: A), a numeric value within upper limit=300 and lower limit=1 is replaced with a numeric value 500 has a single element of the numeric value 500 at the first level (element: A). Therefore, as is obvious from comparison between the numbers of tables in the PST 14A and the PST 14B, by constructing the PST 14B based on the conversion table 12, the memory usage for PST can be significantly reduced.

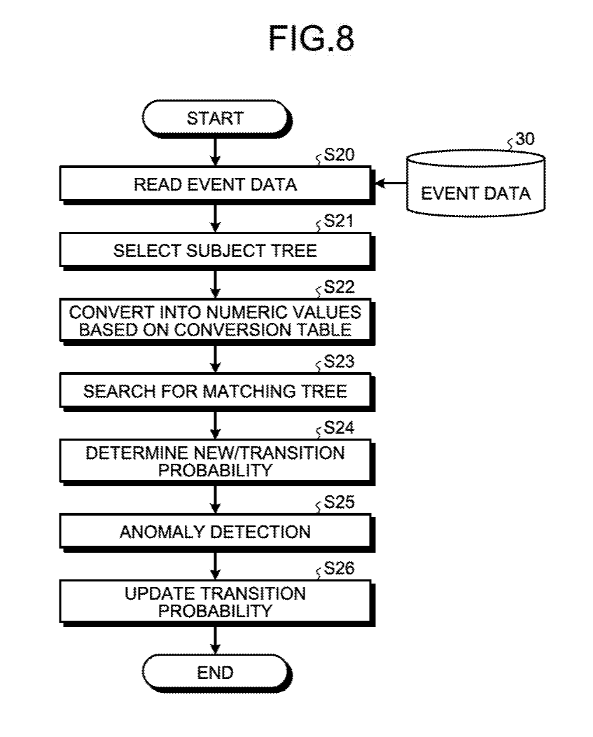

Next, details of processing in the anomaly detection are explained. FIG. 8 is a flowchart indicating one example of processing in the anomaly detection.

As indicated in FIG. 8, when the processing is started, the preprocessing unit 10b reads the event data 30, and creates a current pattern (S20). Subsequently, the preprocessing unit 10b selects the created current pattern as a tree portion (subject tree) to be a subject of searching in the PST 14 (S21). Subsequently, the preprocessing unit 10b performs converts the subject tree into numeric values by the conversion table 12 (S22), and thereby converts into an identical identification value uniformly when values in the subject tree belong to a group indicated in the conversion table 12.

Subsequently, the PST searching unit 15 compares the PST 14 with the subject tree subjected to numeric conversion, and searches for a corresponding tree that matches the subject tree (S23). The anomaly detecting unit 17 determines the transition probability of a new tree having no matching tree/corresponding tree, based on a result of searching by the PST searching unit 15 (S24). Based on a result of determination at S24, the anomaly detecting unit 17 detects as an anomaly when it is new with no matching tree and when the transition probability of the corresponding tree is significantly low being equal to or lower than a predetermined value (S25).

Subsequently, when the subject tree in this processing is connected to the PST 14, the total number of events in the PST 14 increases, and therefore, the PST constructing unit 13 updates the transition probability in the PST 14 (S26). When the subject tree in this processing is not connected to the PST 14, the total number of events in the PST 14 does not change, and therefore, the processing at S26 is skipped, and the processing is ended without updating the transition probability.

Reduction in the number of levels (vertical width) of the PST 14 is explained. In reduction of the number of levels, grouping is performed on multiple number of successive levels (arranged sequence) in the PST 14, thereby compressing the PST 14.

Reduction in the number of levels includes reduction of combination patterns such as array, and reduction of sequence (chronological) patterns.

In the case of combination patterns, grouping is performed by the same method as that in reduction of elements (horizontal width) described above. Specifically, in the PST 14, “plural levels” related to each other are arranged to be adjacent to each other, and grouping is performed by statistical processing (for example, clustering) and the like, and each group is replaced with an identical identification value (one element). In clustering or the like, there is a case in which both levels (vertical width) and elements (horizontal width) are reduced.

In the case of sequence (chronological) patterns, a “pattern” having high appearance frequency (basically, closing) is extracted, and is registered in the conversion table 12 for “substrings”. For example, “1→2→3” is replaced with “N”, and following “nests (destinations)” are all connected right under “N”. A disconnection of a pattern is extracted by frequency (transition probability), and a transition probability of a “substring” is stored for each replaced part. At the time of searching for the PST 14, a replacement display of “N” and the conversion able 12 are recognized, and search is continued. Furthermore, a current pattern is used as a window, and is stored in a storage device, such as a memory and an HDD, together with the conversion table 12, to be used for comparison. Moreover, by storing the window of the current pattern in the storage device together with the conversion table 12, recursive replacement of the “substring” and branching in the middle can also be enabled.

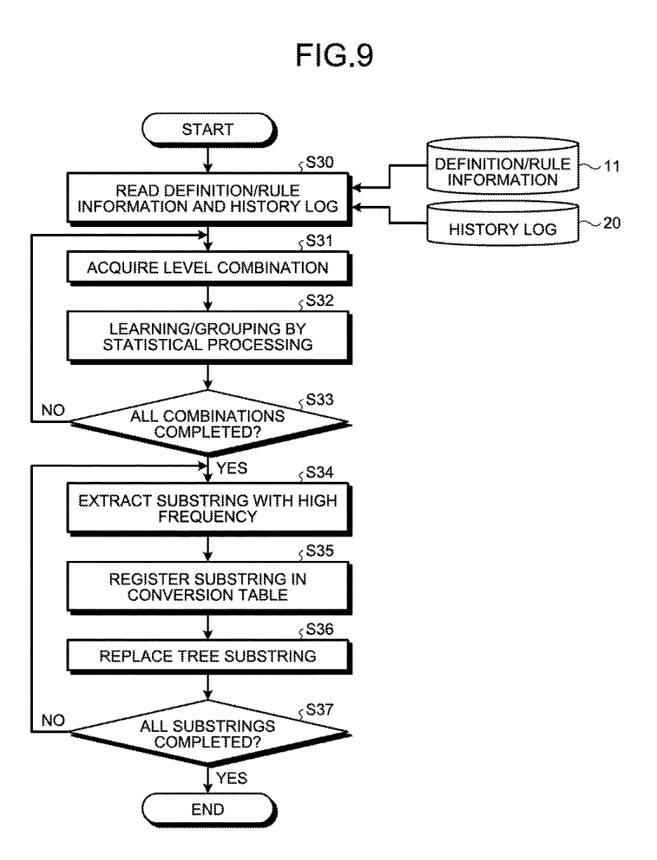

FIG. 9 is a flowchart indicating one example of processing for construction of the PST 14. Specifically, FIG. 9 is a flowchart exemplifying construction of the PST 14 for reducing the number of levels (vertical width). Processing (S30 to S33) in the early stage in FIG. 9 exemplifies processing for reducing combination patterns such as array. Processing (S34 to S37) in a later stage in FIG. 9 exemplifies processing for reducing sequence (chronological) patterns.

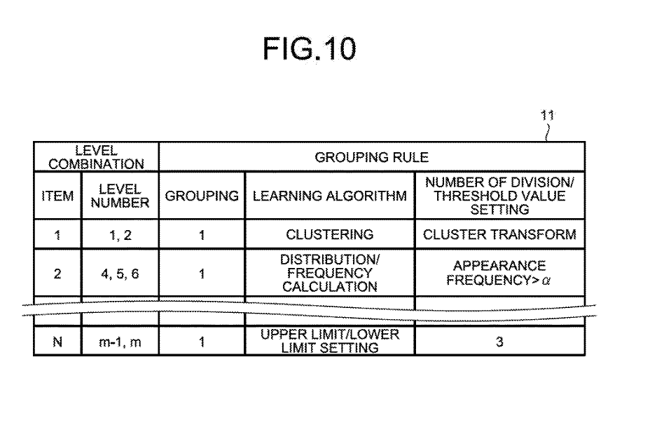

As depicted in FIG. 9, when processing is started, the preprocessing unit 10a reads the definition/rule information 11 and the history log 20 (S30). FIG. 10 is an explanatory diagram explaining the definition/rule information 11. As depicted in FIG. 10, in the definition/rule information 11, a combination of levels according to the combination pattern and a grouping rule is indicated.

Subsequently to S30, the preprocessing unit 10a acquires a level combination that is indicated in the definition/rule information 11 from a tree in the history log 20 (S31). Subsequently, the preprocessing unit 10a performs learning/grouping by statistical processing indicated in the definition/rule information 11 for the acquired combinations (S32).

Subsequently, the preprocessing unit 10a determines whether the processing at S31 and S32 are completed for all of the combinations indicated in the definition/rule information 11 (S33). When the processing at S31 and S32 has not been completed for all of the combinations (S33: NO), the preprocessing unit 10a returns the processing to S31 to perform the processing at S31 and S32 for a next level combination.

At S34, the preprocessing unit 10a extracts a highly frequent substring (sequence), the transition probability of which is equal to or higher than a predetermined value in the PST 14. Subsequently, the preprocessing unit 10a registers the extracted substring in the conversion table 12 together with a corresponding identification value (replacement number) (S35). Subsequently, the preprocessing unit 10a replaces a substring that corresponds to the substring in the conversion table 12 with a replacement number in the PST 14 (S36).

Subsequently, the preprocessing unit 10a determines whether the processing at S34 to S36 has been completed for all of the substrings (S37). When the processing at S34 to S36 has not been completed for all of the substrings (S37: NO), the preprocessing unit 10a returns the processing to S34 to perform the processing at S34 to S36 for a next substring.

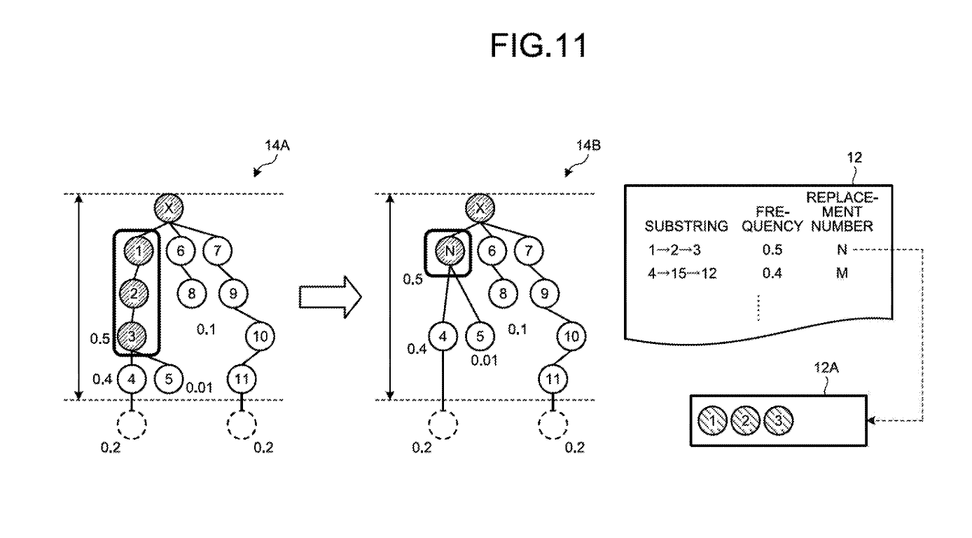

FIG. 11 is an explanatory diagram explaining replacement of substrings in a PST. As depicted in FIG. 11, in the conversion table 12, as the substring “1→2→3” has a high frequency, the replacement number “N” is registered. The preprocessing unit 10a holds a current pattern as a window 12A. The preprocessing unit 10a replaces, when contents (sequence) of the window 12A matches a substring in the conversion table 12, the sequence is replaced with a replacement number. For example, the substring “1→2→3” in the PST 14 is replaced with “N”. Thus, the PST 14A becomes the PST 14B in which the number of levels has been reduced. Thus, by reducing the number of levels, the memory usage for a PST can be reduced.

The case in which the memory usage for a PST is reduced includes, for example, a case of stock price and a case of cluster. As for the case of a stock price, there is a case in which a stock valued at 1000 yen fluctuates in increments of 1 yen up to 1300 (+30%) to hit limit-up, as one example. In this case, by grouping points that fluctuates in increments of 1 yen, 300 elements (branches) from an event of 1000 yen at the root can be handled as a single element. Moreover, in the case of cluster, basically each cluster element is replaced with a single element. Therefore, multiple levels (vertical width) and multiple elements (horizontal width) can be reduced to the number corresponding to the number of clusters.

The PST constructing unit 13 can reconstruct a tree in the PST 14 by sorting in order of the transition probabilities in the PST 14. This sorting mainly includes “sequence, and “array”. In the “sequence”, elements (horizontal width) at the same level are rearranged, starting from the root sequentially toward subordinating levels (toward branches). In “array”, levels (vertical) and elements (horizontal) in the same level are rearranged in a set in descending order of the transition probabilities.

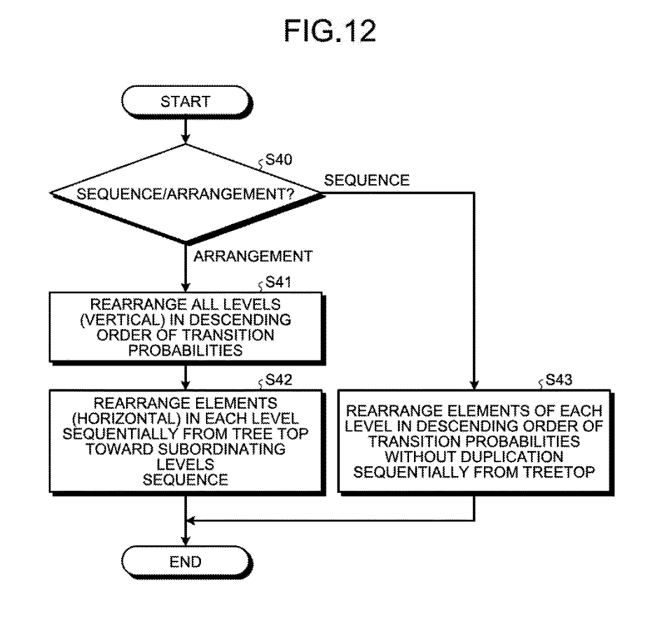

FIG. 12 is a flowchart indicating one example of processing for reconstruction of the PST 14. As indicated in FIG. 12, when processing is started, the PST constructing unit 13 determines either sorting of “sequence” or “array” is to be performed (S40). When determined as “array” at S40, the PST constructing unit 13 refers to the PST 14, and rearranges all levels (vertical) in descending order of transition probabilities (S41). Subsequently, the PST constructing unit 13 rearranges elements, for example, in descending order in each level sequentially from the tree top toward subordinating levels (S42). When determined as “sequence at S40, the PST constructing unit 13 rearranges elements in each levels in descending order of transition probabilities while avoiding duplication, sequentially from the treetop (S43).

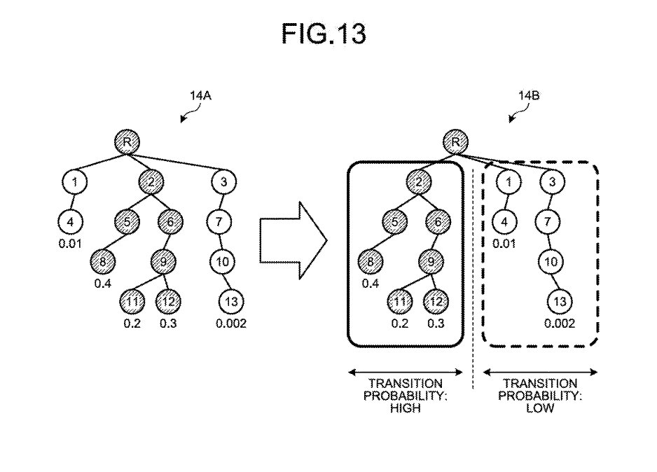

FIG. 13 is an explanatory diagram explaining reconstruction of a PST. As depicted in FIG. 13, the PST 14A before reconstruction has a tree structure in which branches extend irrespective of transition probabilities. To the contrary, the PST 14B after reconstruction has a tree structure in which branches with high transition probabilities are adjacent to each other. Since data having high transition probability has a high access frequency, the probability of being held in a cache of a memory is to be high. Therefore, by reconstruction of the PST 14 by sorting, the cache hit rate at the time of referring to the PST 14 is expected to be improved.

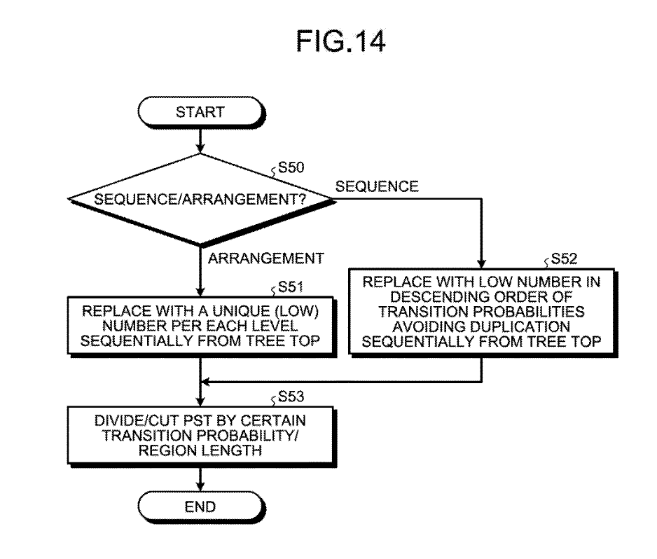

FIG. 14 is a flowchart indicating one example of processing for reconstruction of the PST 14. Specifically, FIG. 14 is another example of the processing exemplified in FIG. 12. In this example, to the reconstructed PST 14, numbers are reassigned from a (low) “number” in descending order of transition probabilities. As for “sequence”, replacement to a (low) number is uniform in the entire part. As for “array”, assignment of a number is independent in each level (vertical), and a “number” can be duplicated among levels.

As indicated in FIG. 14, when processing is started, the PST constructing unit 13 determines either sorting of “sequence” or “array” is to be performed (S50). When determined as “array” at S50, the PST constructing unit 13 refers to the PST 14, and replaces with a (low) number unique to each level sequentially from the tree top (S51). When determined as “sequence” at S50, the PST constructing unit 13 refers to the PST 14, and replaces with low numbers without duplication in descending order of transition probabilities, sequentially from the tree top (S52). Subsequently to S51, S52, the PST constructing unit 13 divides/cuts the PST 14 in a certain transition probability/region length (S53).

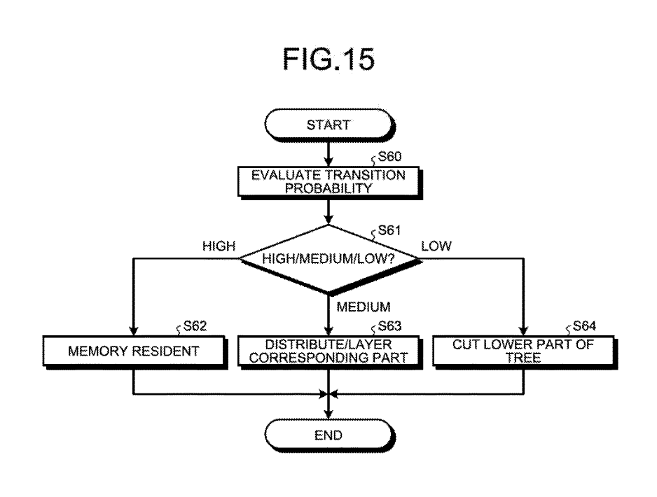

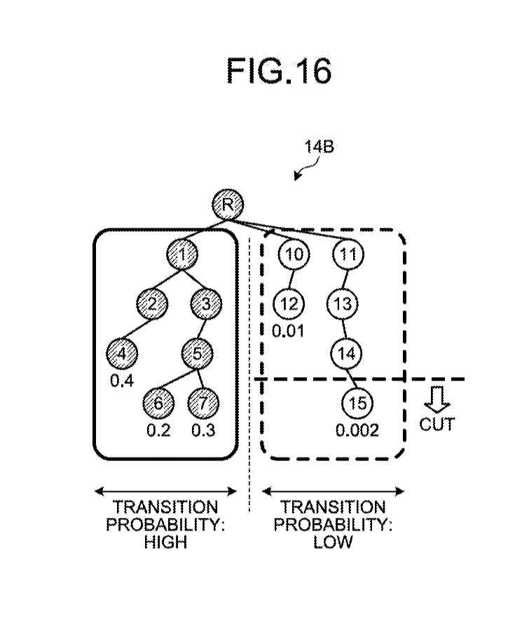

FIG. 15 is a flowchart indicating one example of processing for division/cut of the PST 14. FIG. 16 is an explanatory diagram explaining the division/cut of the PST 14. As indicated in FIG. 15, when processing is started, the PST constructing unit 13 refers to the PST 14, evaluates transition probabilities from the tree top (S60), and compares with a predetermined value to make determination of “HIGH”/“MEDIUM”/“LOW” (S61).

When a transition probability is high (“HIGH”), the PST constructing unit 13 makes the tree evaluated as to have a high transition probability memory resident (S62). Moreover, when a transition probability is medium (“MEDIUM”), the PST constructing unit 13 arranges a part evaluated as to have medium transition probability in the memory in a distributed/layered manner (S63). For example, distribution can be done by arranging to a memory of another server. Layering can be done by arranging in, for example, a disk device (external storage). However, as for divided part, a pointer is held on the memory.

Furthermore, when a transition probability is low (“LOW”), the PST constructing unit 13 cuts a part (lower part of tree) evaluated as to have a low transition probability from the memory (S64). As depicted in FIG. 16, by performing division/cut described above, the memory usage for the PST 14 can be made efficient.

As described above, the preprocessing unit 10a of the detection apparatus 1 converts a value indicating each event that is included in the history log 20 into an identification value that corresponds to the value. Moreover, the preprocessing unit 10a performs processing of converting values that belong to a group indicated in the conversion table 12 into an identical identification value that corresponds to the group, based on the conversion table 12 in which a group of values and an identification value that corresponds to values belonging to this group are indicated. Furthermore, the PST constructing unit 13 of the detection apparatus 1 constructs the PST 14 in which the identification values that are obtained by conversion by the preprocessing unit 10a in order of occurrence of events are sequentially connected from the root, and in which an occurrence probability of an event corresponding to an identification value is assigned to each identification value. Moreover, the preprocessing unit 10b of the detection apparatus 1 converts a value indicating each event included in the event data 30 into an identification value corresponding to a value. Furthermore, the preprocessing unit 10b performs processing of converting values that belong to a group indicated in the conversion table 12 into an identical identification value corresponding to the group, based on the conversion table 12. The anomaly detecting unit 17 of the detection apparatus 1 performs anomaly detection based on a result of comparison between the constructed PST 14 and the identification value obtained by conversion by the preprocessing unit 10b.

Therefore, in the detection apparatus 1, for values indicating respective events that are included in the history log 20, values that belong to a group indicated in the conversion table 12 are converted in to an identical identification value corresponding to the group. Therefore, the memory usage of the PST 14 can be reduced. Moreover, by converting into an identical identification value corresponding to a group, transition probabilities in the PST 14 are concentrated at the identification value corresponding to the group, and therefore, the distribution of “dense/sparse” in transition probabilities becomes sharp and clear. Therefore, the anomaly detection performance (accuracy) by searching of the PST 14 is improved.

The illustrated components of respective devices are not necessarily required to be configured physically as illustrated. That is, a specific form of distribution and integration of the respective devices is not limited to the one illustrated, and all or a part thereof can be configured to be distributed/configured functionally or physically in an arbitrary unit according to various kinds of loads and use conditions.

For example, although a device configuration in a single unit of the detection apparatus 1 has been exemplified in the present embodiment, it can be configured as cloud computing in which multiple storage devices, server devices, and the like are connected through a network.

Moreover, respective processing functions executed in the detection apparatus 1 can be configured such that all or a part thereof is executed on a central processing unit (CPU) (or a microcomputer such as a micro-processing unit (MPU) and a micro controller unit (MCU)). Furthermore, it is needless to say that the respective processing functions can be configured such that all or an arbitrary part thereof is executed on a program that is analyzed and executed by a CPU (or a microcomputer such as an MPU and an MCU), or on hardware by wired logic.

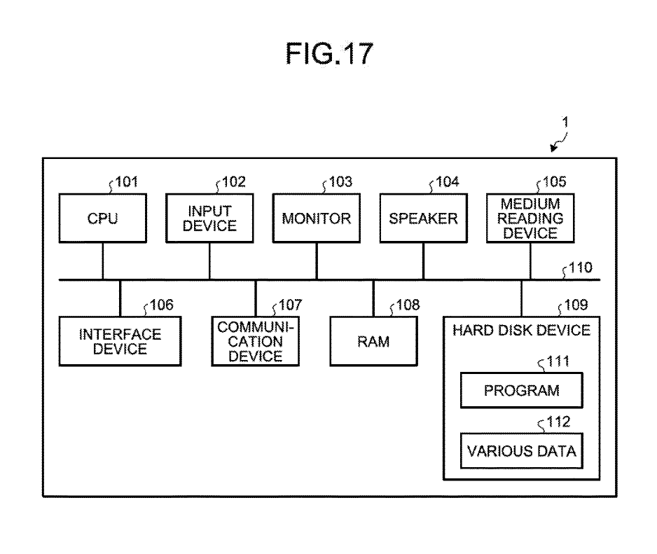

The respective processing explained in the above embodiment can be implemented by executing a program that is prepared in advance by a computer. Therefore, in the following, one example of a computer (hardware) that executes a program that has the same functions as the embodiment described above is explained. FIG. 17 is a block diagram of a hardware configuration of the detection apparatus 1 according to the embodiment.

As depicted in FIG. 17, the detection apparatus 1 includes a CPU 101, that executed various kinds of arithmetic processing, an input device 102 that accepts data input, a monitor 103, and a speaker 104. Moreover, the detection apparatus 1 includes a medium reading device 105, that reads a program and the like from a storage medium, an interface device 106 to connect to various devices, and a communication device 107 to connect to an external device by wired or wireless communication. Furthermore, the detection apparatus 1 includes a RAM 108 that temporarily stores various kinds of information and a hard disk device 109. Moreover, the respective components (101 to 109) in the detection apparatus 1 are connected to a bus 110.

In the hard disk device 109, a program 111 to perform various kinds of processing in the preprocessing units 10a, 10b, the conversion table 12, the PST constructing unit 13, the PST searching unit 15, the distributing/layering processing unit 16, and the anomaly detecting unit 17 explained in the above embodiment is stored. Furthermore, in the hard disk device 109, various kinds of data 112 (the definition/rule information 11, the conversion table 12, the PST 14, the history log 20, the event data 30, and the like) that is referred to by the program 111 is stored. The input device 102 accepts an input of, for example, operation information from an operator of the detection apparatus 1. The monitor 103 displays various kinds of screens that is operated by the operator, for example. To the interface device 106, for example, a printer device and the like are connected. The communication device 107 is connected to a communication networks such as a local area network (LAN), and communicates various kinds of information with an external device through the communication network.

The CPU 101 reads the program 111 stored in the hard disk device 109, and develops and executes the program 111 on the RAM 108, to perform various kinds of processing. The program 111 is not necessarily required to be stored in the hard disk device 109. For example, it can be configured such that the detection apparatus 1 reads the program 111 stored in a storage medium that can be read by the detection apparatus 1 to execute it. The storage medium that can be read by the detection apparatus 1 corresponds to a portable recording medium such as a compact disk read-only memory (CD-ROM), a digital versatile disk (DVD), a universal serial bus (USB) memory, a semiconductor memory such as a flash memory, a hard disk drive, and the like. Moreover, it can be configured such that the program 111 can be stored in a device connected to a public line, the Internet, a LAN, or the like, and the program 111 is read and executed by the detection apparatus 1 therefrom.

According to one embodiment of the present invention, memory usage in anomaly detection can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a detection program that causes a computer to execute a process including:
performing a first conversion processing to convert a value indicating each event that is included in history log into an identification value corresponding to the value, and to convert, based on conversion information that indicates a group of the value and an identification value that corresponds to values belonging to the group, values that belong to a group indicated in the conversion information into an identical identification value that corresponds to the group;
constructing information with occurrence probabilities by connecting identification values that are obtained by conversion by the first conversion processing in order of occurrence of the event sequentially from a root, and by assigning an occurrence probability of an event that corresponds to the identification value per identification value;
performing second conversion processing to convert a value indicating each event included in event data that is input according to an event has occurred into an identification value corresponding to the value, and to convert values that belong to a group indicated in the conversion information into an identical identification value corresponding to the group based on the conversion information; and
detecting an anomaly based on a result of comparison between the constructed information with occurrence probabilities and the identification value that is obtained by conversion by the second conversion processing.

2. The non-transitory computer-readable recording medium according to claim 1, wherein
the conversion information indicates a range of values as the group, and
the first and the second conversion processing converts values within the range indicated in the conversion information into an identical identification value that corresponds to the range.

3. The non-transitory computer-readable recording medium according to claim 2, wherein the process further including:
calculating a statistical distribution of values indicating respective events that are included in the history log, and of creating conversion information in which a range of the values and an identification value corresponding to the range is defined, wherein
the first and the second conversion processing performs conversion processing based on the created conversion information.

4. The non-transitory computer-readable recording medium according to claim 1, wherein
the conversion information indicates order of array of values as the group, and
the first and the second conversion processing converts values arranged in the order of array indicated in the conversion information into an identical identification value corresponding to the order of array.

5. The non-transitory computer-readable recording medium according to claim 4, wherein the process further including:
calculating an appearance frequency according to order of array of values that indicate respective events included in the history log, and of creating conversion information in which the order of array having the appearance frequency equal to or higher than a predetermined value and an identification value that corresponds to the order of array are defined, wherein
the first and the second conversion processing performs conversion processing based on the created conversion information.

6. A detection method comprising:
performing a first conversion processing to convert a value indicating each event that is included in history log into an identification value corresponding to the value, and to convert, based on conversion information that indicates a group of the value and an identification value that corresponds to values belonging to the group, values that belong to a group indicated in the conversion information into an identical identification value that corresponds to the group by a processor;
constructing information with occurrence probabilities by connecting identification values that are obtained by conversion by the first conversion processing in order of occurrence of the event sequentially from a root, and by assigning an occurrence probability of an event that corresponds to the identification value per identification value by the processor;
performing second conversion processing to convert a value indicating each event included in event data that is input according to an event has occurred into an identification value corresponding to the value, and to convert values that belong to a group indicated in the conversion information into an identical identification value corresponding to the group based on the conversion information by the processor; and
detecting an anomaly based on a result of comparison between the constructed information with occurrence probabilities and the identification value that is obtained by conversion by the second conversion processing by the processor.

7. The detection method according to claim 6, wherein
the conversion information indicates a range of values as the group, and
the first and the second conversion processing converts values within the range indicated in the conversion information into an identical identification value that corresponds to the range.

8. The detection method according to claim 7, further comprising:
calculating a statistical distribution of values indicating respective events that are included in the history log, and of creating conversion information in which a range of the values and an identification value corresponding to the range is defined, by the processor, wherein
the first and the second conversion processing performs conversion processing based on the created conversion information.

9. The detection method according to claim 6, wherein
the conversion information indicates order of array of values as the group, and
the first and the second conversion processing converts values arranged in the order of array indicated in the conversion information into an identical identification value corresponding to the order of array.

10. The detection method according to claim 9, further comprising:
calculating an appearance frequency according to order of array of values that indicate respective events included in the history log, and of creating conversion information in which the order of array having the appearance frequency equal to or higher than a predetermined value and an identification value that corresponds to the order of array are defined, by the processor, wherein
the first and the second conversion processing performs conversion processing based on the created conversion information.

11. A detection apparatus comprising a processor that executes a process comprising:
performing a first conversion processing to convert a value indicating each event that is included in history log into an identification value corresponding to the value, and to convert, based on conversion information that indicates a group of the value and an identification value that corresponds to values belonging to the group, values that belong to a group indicated in the conversion information into an identical identification value that corresponds to the group;
constructing information with occurrence probabilities by connecting identification values that are obtained by conversion by the first conversion processing in order of occurrence of the event sequentially from a root, and by assigning an occurrence probability of an event that corresponds to the identification value per identification value;
performing second conversion processing to convert a value indicating each event included in event data that is input according to an event has occurred into an identification value corresponding to the value, and to convert values that belong to a group indicated in the conversion information into an identical identification value corresponding to the group based on the conversion information; and
detecting an anomaly based on a result of comparison between the constructed information with occurrence probabilities and the identification value that is obtained by conversion by the second conversion processing.

12. The detection apparatus according to claim 11, wherein
the conversion information indicates a range of values as the group, and
the first and the second conversion processing converts values within the range indicated in the conversion information into an identical identification value that corresponds to the range.

13. The detection apparatus according to claim 12, wherein the process further comprising:
calculating a statistical distribution of values indicating respective events that are included in the history log, and of creating conversion information in which a range of the values and an identification value corresponding to the range is defined, by the processor, wherein
the first and the second conversion processing performs conversion processing based on the created conversion information.

14. The detection apparatus according to claim 11, wherein
the conversion information indicates order of array of values as the group, and
the first and the second conversion processing converts values arranged in the order of array indicated in the conversion information into an identical identification value corresponding to the order of array.

15. The detection apparatus according to claim 14, wherein the process further comprising:
calculating an appearance frequency according to order of array of values that indicate respective events included in the history log, and of creating conversion information in which the order of array having the appearance frequency equal to or higher than a predetermined value and an identification value that corresponds to the order of array are defined, by the processor, wherein
the first and the second conversion processing performs conversion processing based on the created conversion information.
